(19) United States
(12) Patent Application Publication
(10) Pub. No.: US 2003/0167230 A1
(43) Pub. Date: Sep. 4, 2003

(54) Method and communication terminal for handling payment of downloadable content

(76) Inventor: Kevin McCarthy, Vaerloese (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/084,982

(22) Filed: Mar. 1, 2002

(51) Int. Cl. G06F 17/60

(52) U.S. Cl. 705/40; 705/26

(57) ABSTRACT

Content subject to payment is downloadable from a content provider to a wireless terminal via a communication network. A software application an in said wireless terminal is opened, the downloadable content is requested from the open software application. The terminal automatically starts up a network session, and transmits a request for downloading said downloadable content for the software application. When the content provider replies to said request by sending the content, the wireless terminal receives said content for the software application for pre-study (pre-view, listning, feeling etc). Payment for said downloadable content for the software application for enabling storing of said downloadable content for the software application is handled, whereby storing of said downloadable content for the software application from which the downloadable content becomes possible.

### BACKGROUND OF THE INVENTION

The invention relates to a concept for handling payment of downloadable content from a content provider to a wireless terminal via a communication network.

Presently this kind of content is downloaded from the Internet using a Personal Computer by means of which the item is selected and the wireless terminal, or by means of the newspapers having a selection list and a phone number to which the user has to send an SMS message.

### SUMMARY OF THE INVENTION

According to a first aspect of the invention there is provided a method of handling payment of downloadable content from a content provider to a wireless terminal via a communication network. The method comprises step of opening a software application in said wireless terminal, requesting downloadable content from the open software application, automatically starting up a network session, transmitting in said network session a request for downloading said downloadable content for the software application, receiving said downloadable content for the software application for pre-study, handling of payment for said downloadable content for the software application for enabling storing of said downloadable content for the software application, and storing of said downloadable content for the software application from which the downloadable content for the software application was requested. Hereby the user obtains an easy way to verify whether he is satisfied with a downloadable item before he purchases the item, and this verification is done in the environment in which the item will be used.

The requested downloadable content may include at least one of the following items, a ring tune, a tactile feedback from a vibrator, a graphic icon, an animation, and a new maze or background for a game. Preferably, the network session is a WAP session. Advantageously the WAP session is established with a pre-identified content provider. The user of the wireless terminal has according to the preferred embodiment of the invention an account at the pre-identified content provider, and wherein the handling of payment for said downloadable content includes transfer of an amount from said account to the content provider upon approval by the user. The storing of said downloadable content is enabled once the user has approved said payment.

According to a further aspect of the invention, there is provided a wireless terminal via a communication network, and comprising at least one software application, said at least one software application comprises means for the user for requesting downloadable content, means for automatically starting up a network session upon detection of a user entered request, means for transmitting a request in said network session for downloading said downloadable content to a content source, means for receiving said downloaded content for the software application for pre-study, means for handling of payment for said downloaded content for the software application, and means for storing of said downloaded content for use with the software application from which the downloadable content was requested once payment has been handled. Hereby the user obtains an easy way to verify whether he is satisfied with a downloadable item before he purchases the item, and this verification is done in the environment in which the item will be used.

The requested downloadable content includes at least one of the following items, a ring tune, a tactile feedback from a vibrator, a graphic icon, an animation, and a new maze or background for a game.

Preferably, the networks session is a WAP session, and the WAP session is established with a pre-identified content provider.

### BRIEF DESCRIPTION OF THE DRAWING

For a better understanding of the present invention and to understand how the same may be brought into effect reference will now be made, by way of example only, to accompanying drawings, in which:

FIG. 1 schematically illustrates a preferred embodiment of a hand portable phone according to the invention.

FIG. 2 schematically shows the essential parts of a telephone for communication with e.g. a cellular network.

FIG. 3 shows a network session according to the preferred embodiment of the invention.

FIG. 4 shows a menu structure for a wireless terminal according to a preferred embodiment of the invention.

FIG. 5 shows a flow chart for the content download concept according to a preferred embodiment of the invention.

FIG. 6 shows display images occurring during the preferred implementation of content download according to the invention

### DETAILED DESCRIPTION OF THE INVENTION

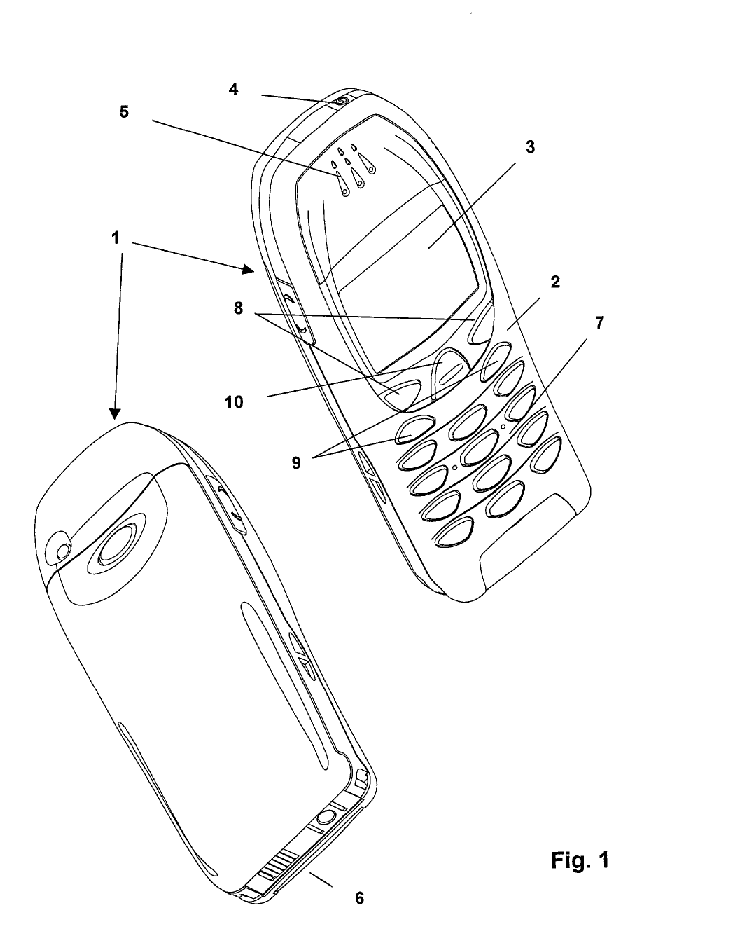

FIG. 1 shows a preferred embodiment of a terminal for handling payment of downloadable content according to the invention, such as a cellular phone 1, which comprises a user interface having a keypad 2, a display 3, an on/off button 4, a speaker 5 (only openings are shown), and a microphone 6 (only openings are shown).

According to the preferred embodiment of the invention the keypad 2 has a first group 7 of keys as alphanumeric keys, two softkeys 8, and a scroll-key 10 (up/down) for moving a cursor in the display. Furthermore the keypad includes two call-handling keys 9 for initiating and terminating calls. The present functionality of the softkeys 8 is shown in a separate field in the bottom of the display 3 just above the softkeys 8.

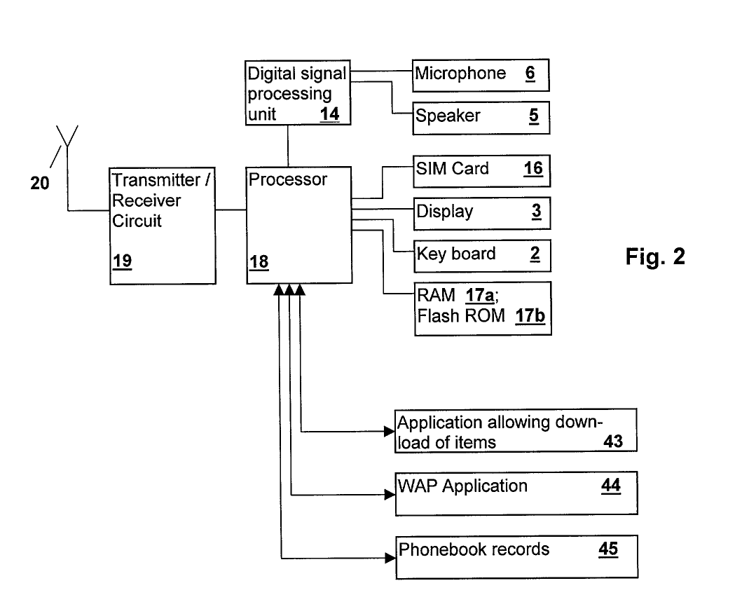

FIG. 2 schematically shows the most important parts of a preferred embodiment of the phone, said parts being essential to the understanding of the invention. A processor 18, which supports the GSM terminal software, also controls the communication with the network via the transmitter/receiver circuit 19 and an antenna 20.

The microphone 6 transforms the users speech into analogue signals; the signals formed thereby are A/D converted in an AND converter (not shown) before the speech is encoded in an audio part 14. The encoded speech signal is transferred to the processor 18. The processor 18 also forms the interface to a RAM memory 17a and a Flash ROM memory 17b, a SIM card 16, the display 3 and the keypad 2 (as well as data, power supply, etc.). The audio part 14 speech-decodes the signal, which is transferred from the processor 18 to the earpiece 5 via a D/A converter (not shown).

When user input is needed in application programs, such as an SMS message handling application 43, a WAP browser application 44, and for searching in phonebook records 45, the processor 18 opens a character entry application 50 in which the user may enter characters and use the entered character strings in the application from which the character entry application 50 is opened.

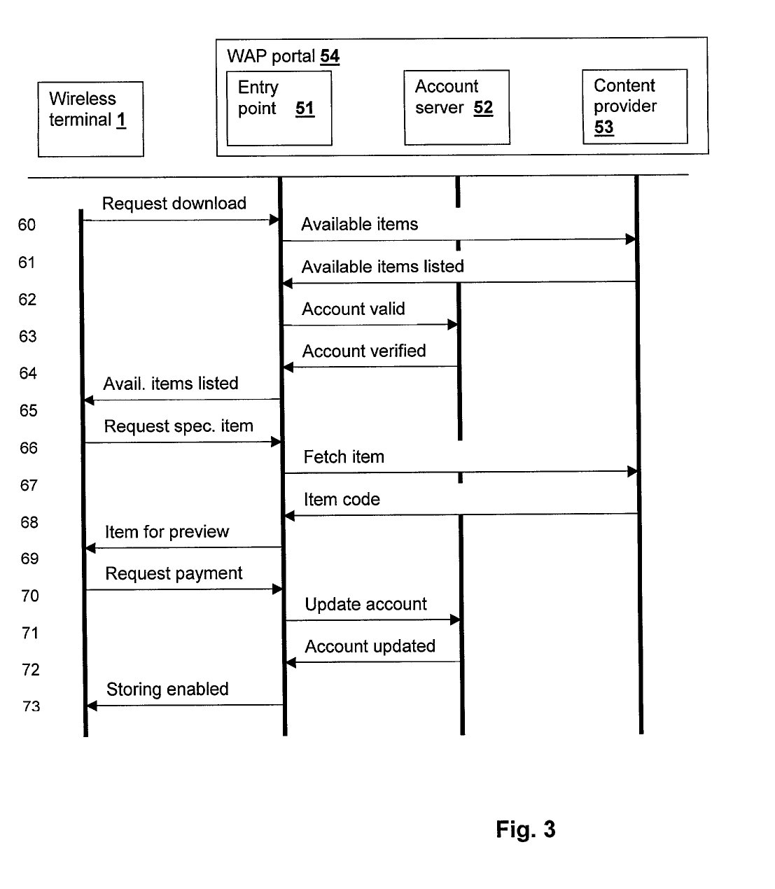

Reference is made to FIG. 3. According to the preferred embodiment of the invention, the wireless terminal 1 sets up a network session for downloading content from a content provider 53. According to the shown embodiment the content provider 53 is hosted by a WAP portal 54. The WAP portal 54 also host an account service 52—or at least has an account service associated therewith—and perhaps further content providers (not shown).

The phone user has to enter into an agreement with the content providers and the account service, and this may be done as a part of the subscription agreement when the phone user purchases the phone. When the agreement has been entered, the required information will be stored on the SIM card 16 for retrieval when a session has to be set up. The required information includes the phone number of the WAP portal; ID for the phone (e.g. the phone number) keys for authentication of the subscriber, etc.

According to the preferred embodiment the terminal 1 starts the session by sending a request 60 to an entry point 51 in the WAP portal 54. Dialing the phone number of the WAP portal 54 retrieved from the SIM card 16 does this. A secure session (WAP known under the WAP protocol) is set up by the request 60. If the request is set up in a game application, the request 60 includes an identification of the terminal hardware and what games and game levels are presently installed.

This information is passed as a request for available items 61 to the content provider 53. The content provider replies with a reply 62 including a list of available items matching the hardware and preferably not being present in the wireless terminal 1 yet. Prices for the individual items are included, too. Simultaneously an enquiry 63 is sent to the account server 52 concerning the validity and status of the account associated with the wireless terminal 1. The account server 52 gives a reply 64 including the account level.

Once this data is received at the entry point 51, a list 65 including available items is sent to the wireless terminal 1 as a reply to the download request 60. This list of available items will be displayed for the user in the application from which the download was requested.

Now the user has an opportunity to request a specific item, e.g. a new game and a new game variant/level, a picture/animation or a ring tone, for download. The request 66 is sent to the entry point 51, from where an instruction 67 for fetching the requested item is forwarded to the content provider 53. The item code 68 is sent to the entry point 51, from where the item code 69 is sent to the wireless terminal 1. The application from which the download was requested allows the user to e.g. preview the game or the picture/animation or listen to the ringing tune. This pre-inspection of the downloaded item is free. The user has an opportunity to discard the down loaded item, whereby no payment is made.

However if the user wants to save the downloaded item, he gives this instruction in the application from which the download was requested, and a request 70 for payment instruction is sent to the entry point 51, and the account server 52 is given an instruction 71 to draw the amount from the user account. The account server 52 sends an acknowledgement 72 confirming the account up-date, and a code 73 enabling the storing of the pre-viewed item is sent to the wireless terminal 1.

The download session is handled seamlessly, i.e. the user does not have to identify the WAP portal 54, neither initiating nor terminating the call. If the session is interrupted after the wireless terminal 1 has received the list 65 including available items these steps do not have to be repeated if the session is re-started within a predetermined period of e.g. 24 hours. This is the same if a second item, similar to the first item, is requested for download. The list of available items is kept in the wireless terminal for a pre-determinedperiod.

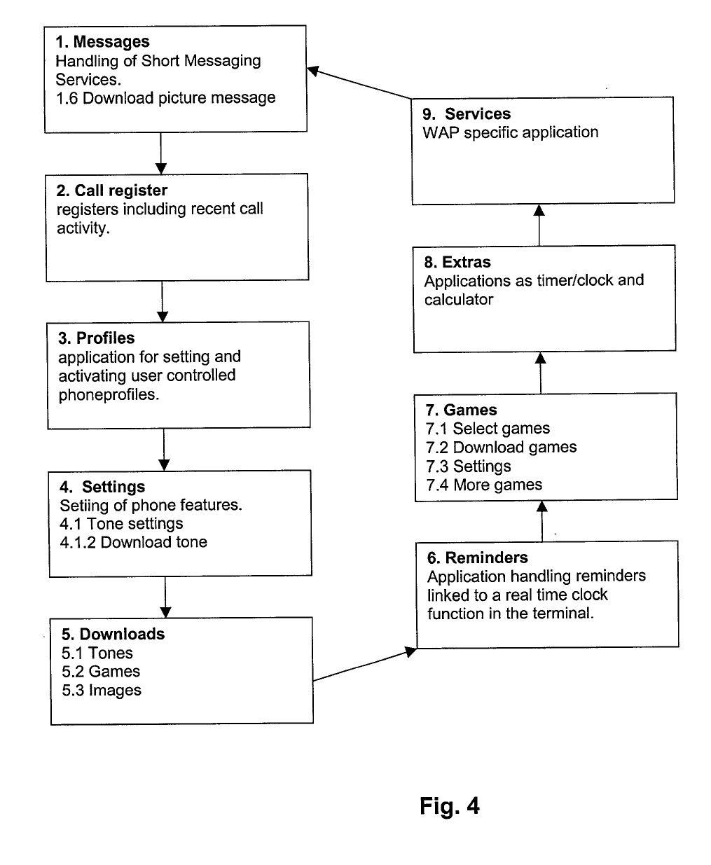

FIG. 4 illustrates a preferred embodiment of a Menu structure for a wireless terminal according to the invention. The present menu includes nine main menus, e.g. “1. Messages”, “2. Call register” etc.

Each main menu includes a plurality of submenus, and from some of the content download may be initiated, e.g. the “1.6 Download picture message” submenu, the “4.1.2 Download tone” submenu, the “7.2 Download game” submenu, and the “5.1 tones”, the “5.2 Games”, the “5.3 Images” submenu's in the “5 Downloads” menu. Downloads” main menu.

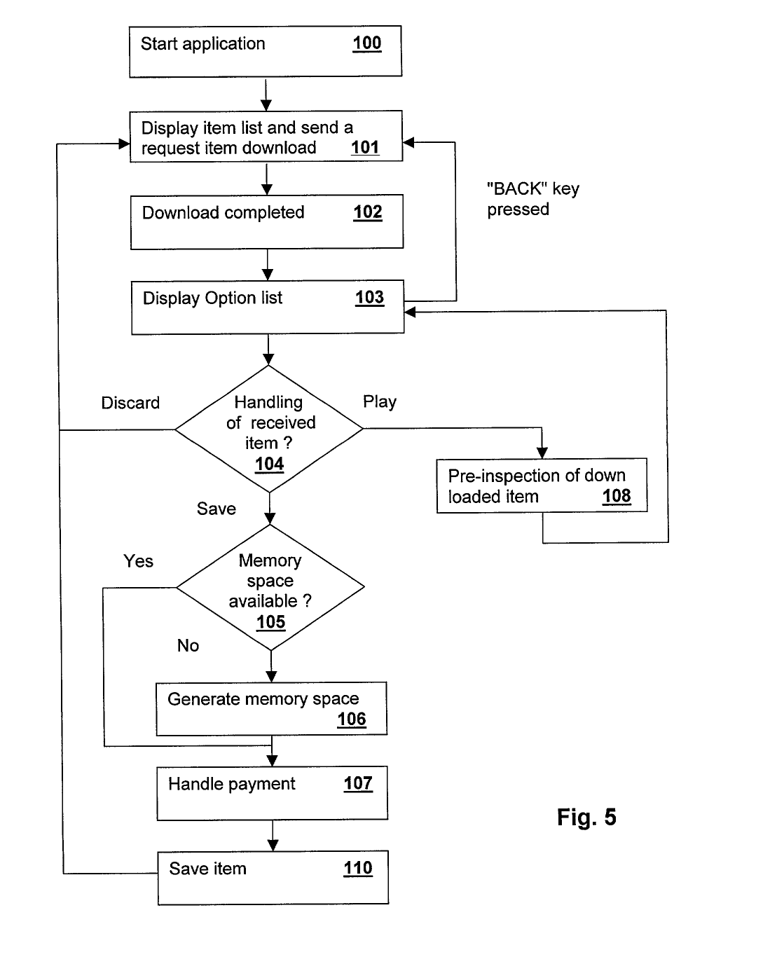

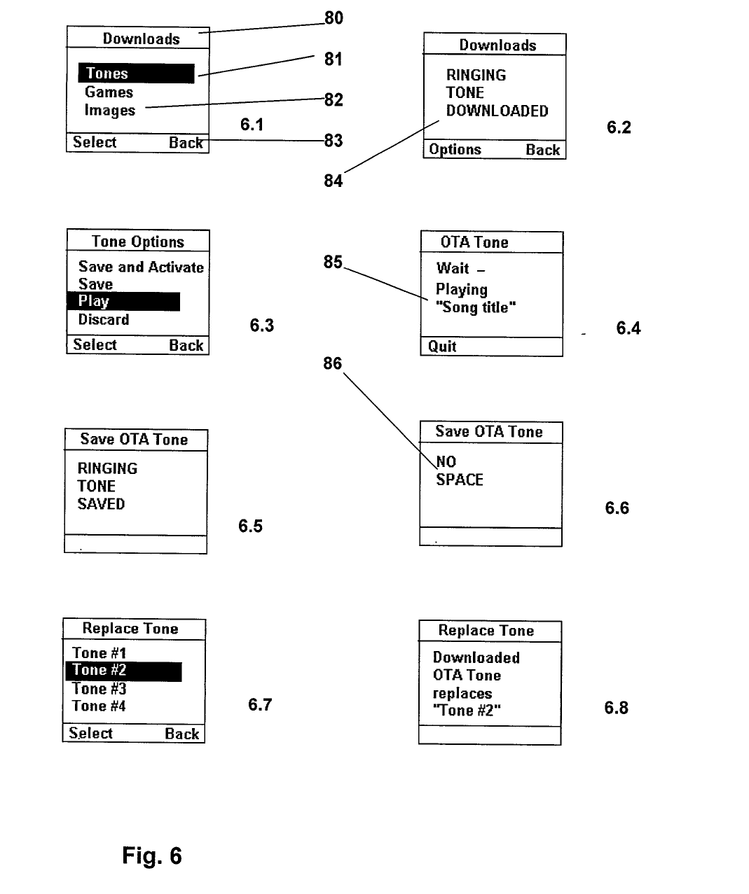

In FIG. 5 the content download concept according to a preferred embodiment of the invention is illustrated by means of a flow chart. When the user initiates an application in step 100. When the user selects one of the sub-items allowing him to download content, the download session is initiated with a predetermined WAP site 54 providing a list of items that may be downloaded. The image 6.1 in FIG. 6 shows the submenu items in the download main menu. The display has a header 80 identifying where in the menu the user is operating. Submenu item 82 is shown with a presently selected item marked with an inverted bar 81. Softkey options are displayed in a softkey display part 83.

This list of available downloads depends on where in the menu the download was requested and is displayed in step 101. The list may include a plurality of ring tones. When the download of one of these items is completed in step 102, a confirmation text 84 (image 6.2 of FIG. 6) is displayed. An option list (image 6.3 of FIG. 6) is displayed in step 103. Here the user has an opportunity to discard the downloaded item, preview or listen to the tone or save the downloaded item, e.g. a tone in step 104. If the user presses the “Back” soft key or selects “Discard” the terminal goes back to step 101 without saving the downloaded item, e.g. a tone.

If the user wants to pre-inspect the downloaded item, e.g. listen to the ring tone by selecting the “Play” option, the tone is played, and a notification note 85 is displayed in image 6.4 of FIG. 6. When the pre-inspection of the downloaded item, e.g. a tone is finished or when the user selects to “Quit”, the terminal goes back to step 103, whereby the “option” list is displayed again.

When the user in step 104 want to save the downloaded item, e.g. a tone, either directly from the options list or via the pre-inspection facility, he has to select the “Save” item in step 104. The wireless terminal I checks whether there is sufficient memory space in step 105, and if there is sufficient memory space, the remote WAP site 54 is instructed to handle payment (step 107) for the item (message 70, FIG. 3), and when the storing has been enabled and the item saved at step 110, a notification note saying “RINGING TONE SAVED” is displayed, see image 6.5 in FIG. 6. After this the terminal jumps back to step 101 for displaying the items being available for a new download.

If no empty memory space is available in step 105, a notification note saying “NO SPACE” notifies the user about this, see image 6.6 in FIG. 6. After a few seconds the terminal display switches automatically to an option list, see image 6.7, in which the user is invited to identify a previously stored ringing tone for being replaced by the ringing tone to be downloaded. If the user selects a tone for replacement a notification saying that the “DOWNLOADED OTA TONE REPLACES <<name of the tone to be replaced>>”, see image 6.8 in FIG. 6. Hereafter the payment and saving is handled as if there was sufficient memory space.

In the following the same will be described by means of the interface between the user and the terminal for the download of games, tones and pictures. The preferred embodiment of the invention allows the user to download content, such as ringing tones, pictures, animations, games and vibrating pattern via WAP.

The user can use the downloaded items directly upon download. The downloaded items will be stored under the respective application from where the user can access it. Smart Content Download requires according to the preferred embodiment of the invention a WAP Browser.

The Smart Content Download concept according to the preferred embodiment of the invention can be accessed from:

Main Menu item DOWNLOADS.

“DOWNLOAD TONE” item in the TONES Main Menu item.

“DOWNLOAD GAME” item in the GAMES Main Menu item.

“DOWNLOAD IMAGE” item in the SCREEN SAVER Full Window Choice Item.

The following data related to Smart Content Download can be stored and modified:

TABLE 1
data description.

| Data | Note |
|---|---|
| Tone | Standard Nokia Ringing tones |
| Game content | Includes full games and individual game levels |
| Image | Bitmaps (.bmp), Graphics Interchange Format (.gif) |
| | and animated .gifs |
| Vibrating pattern | Specification of vibration profile by defining duty |
| | cycle (PWM) and superposed modulation |

The Smart Content Download concept according to the preferred embodiment of the invention enables the user to download Tones, Game content, vibration and Images, and to activate/use the downloaded content immediately.

The Smart Content Download concept according to the preferred embodiment of the invention can be initiated via the Main Menu item “DOWNLOADS”. Through this Main Menu item, the user gains access to a list of links pointing to downloadable items. The items function as WAP bookmarks in that they initiate a browsing session and connect to a pre-determined WAP page.

The links are presented as a selection list of one row choice items, such as:

TONES

GAMES

IMAGES

VIBRATION

The left softkey is “SELECT” and the right softkey is “BACK”. The Header text is “DOWNLOADS”.

The phone connects to a predetermined WAP page from where the user can download tones, games or game levels, vibration profiles or images to use e.g. as screen savers.

Furthermore, under the “TONES” main menu item there is a Full Window Choice Item “DOWNLOAD TONE”. By selecting this item, the user initiates a browsing session and connects to a pre-determined WAP page, from where the user can select and download ringing tones. The header text for the Full Window Choice Item is “TONES”.

Similar to this, the user is able to access a One Row Choice Item, “Download game”, under the “GAMES” main menu item. By selecting this item the user initiates a browsing session and connects to a pre-determined WAP page, from where the user can select and download games and game levels. The header text for the One Row Choice Item is “GAMES”

Under the “Screen Saver” main menu item is a One Row Choice Item “Download screen saver”. Selecting this item initiates a browsing session and connects to a pre-determined WAP page, from where the user can select and download images which can be used, e.g. as screen savers. The header text for the One Row Choice Item is “SCREEN SAVER”.

Under the “Vibrator profile” menu item is a One Row Choice Item “Download vibrator profile”. Selecting this item initiates a browsing session and connects to a pre-determined WAP page, from where the user can select and download a vibrator profile which can be used, e.g. as tactile feed back in games or as alert signal for the terminal. The header text for the One Row Choice Item is “VIBRATOR PROFILE”.

Downloading Content

Now the procedures for downloading the supported content types will be described. It is assumed that the user has selected a link on a page accessed via the “DOWNLOAD” main menu item or one of the feature specific download menu items as described above. Functionality for both Content Purchase (Buy) and Content Preview are covered.

Tone Purchase

From the WAP page, the user can select a link to purchase a tone. The content provider defines the text used. After selecting the link, content download is initiated. When download is complete, the user is informed by means of a note with text “RINGING TONE DOWNLOADED”. The layout used is Confirmation Query. The left softkey is “OPTIONS”, while the right softkey is “BACK”. By pressing the left “OPTIONS” softkey a selection list of one row choice items will be displayed, including: “SAVE AND ACTIVATE”, “SAVE”, “PLAY”, and “DISCARD”. The header text is TONE OPTIONS.

If the user presses the “BACK” softkey from either the Confirmation Query or the Selection List, a confirmation query with the text “DISCARD RINGING TONE” is displayed. If the user accepts the query, the tone is discarded, and a Confirmation Note with text “RINGING TONE DISCARDED”. If the user rejects the query, the phone returns to the options list.

Save and Activate

If the user selects the “SAVE AND ACTIVATE” one row choice item, the downloaded tone is saved and activated as the ringing tone for the current selected profile. Profiles are described in U.S. Pat. No. 5,479,476, and this patent is hereby incorporated by reference.

When the user selects the item, a confirmation note with text “TONE SAVED AND ACTIVATED” is displayed. The display then returns to a WAP page specified by the content provider. If the user selects “SAVE AND ACTIVATE” and there is not an empty space for the ringing tone, one of the old ringing tones has to be replaced with the new one. An Information Note “NO SPACE” is displayed, and then a selection list of ringing tones is displayed. The default selection is the first ringing tone. Softkeys are “SELECT” and “BACK”. The header for Selection list of ringing tones is “REPLACE TONE”.

The phone displays a Confirmation Query with display text “REPLACE Tone #K”, where Tone #K is a name of the programmable ringing tone from the tone selection list. If storing is not successful, the Information note “ERROR” is displayed.

Save.

If the user selects the “SAVE” one row choice item, the downloaded tone is saved to the phone memory. When the user selects the item, a Confirmation Note with text “RINGING TONE SAVED” is displayed. The display then returns to a WAP page specified by the content provider.

If the user selects “SAVE” and there is not an empty space for the ringing tone, one of the old ringing tones has to be replaced with the new one. An Information Note “NO SPACE” is displayed, and then a selection list of ringing tones is displayed. The default selection is the first ringing tone. Softkey labels are “SELECT” and “BACK”. The header for Selection list of ringing tones is “REPLACE TONE”.

The phone displays a Confirmation Query with display text “REPLACE Tone #K”, where Tone #K is a name of the programmable ringing tone from the tone selection list. If storing is not successful, the Information Note “ERROR” is displayed.

Play.

If the user selects the “PLAY” one row choice item, the downloaded tone is played. The used display layout is Wait Note Layout with the song title from the downloaded Ringing Tone. The header is “PLAY OTA TONE”. The right softkey is “QUIT”. After the playing is interrupted, the selection list is displayed again.

Discard.

If the user selects the “DISCARD” one row choice item, a confirmation query with the text “DISCARD RINGING TONE” is displayed. If the user accepts the query, the tone is discarded, and a Confirmation Note with text “RINGING TONE DISCARDED”, and the phone returns to a WAP page specified by the content provider. If the user rejects the query, the phone returns to the downloaded tone options list (see above)

Preview Tone.

From the WAP page, the user can select a link to preview a tone. The text used is defined by the content provider. If the user selects the preview link, the selected tone is played.

The used display layout is Wait Note Layout with the song title from the selected Ringing Tone. The right softkey is “QUIT”. After the playing is interrupted or stopped, the phone returns to the WAP page.

Downloading and Purchasing of a Game Concept.

From the WAP page, the user can select a link to purchase game content. This can be either a complete game, or an extra game level for an existing game. The content provider defines the text used. After selecting the link, content download is initiated.

When download is complete, the user is informed by means of a note with text “GAME LEVEL DOWNLOADED” or “GAME DOWNLOADED” depending on the type of content. The layout used is Confirmation Query. The left softkey is “OPTIONS”, and the right softkey is “BACK”. By pressing the “OPTIONS” softkey a selection list of row items is displayed, including “Save and play”, “Save”, and “Discard”. The header text is GAME OPTIONS.

If the user presses the “BACK” softkey from either the Confirmation Query or the Selection List, a confirmation query with the text “DISCARD GAME LEVEL”/“DISCARD GAME” is displayed. If the user accepts the query, the game content is discarded, and a Confirmation Note with text “GAME LEVEL DISCARDED”/“GAME DISCARDED”. If the user rejects the query, the phone returns to the options list.

Save and Play.

If the user selects the “SAVE AND PLAY” one row choice item, a Confirmation Note with text “GAME LEVEL SAVED”/“GAME SAVED” is displayed. The downloaded game content is saved and the browser connection is closed. The game is then started.

When the user finishes playing, normal Games functionality is used—i.e. the user stays in the Games menu. If the user selects “SAVE AND PLAY” and there is not an empty space for the game content, one of the old games or game levels has to be replaced with the new one. An Information Note “NO SPACE” is displayed, and then a selection list of games and game levels is displayed. The user can scroll through the list using the scroll keys. Softkey labels are “SELECT” and “BACK”. The header is “REPLACE GAME”/“REPLACE GAME LEVEL”.

The phone displays a Confirmation Query with display text “REPLACE GAME?”/“REPLACE GAME LEVEL?” If storing is not successful the Information note “SAVE FAILED” is displayed.

Save.

If the user selects the “SAVE” one row choice item, the downloaded game content is saved to the phones memory. When the user selects the item, a Confirmation Note with text “GAME LEVEL SAVED”/“GAME SAVED” is displayed. The display then returns to a WAP page specified by the content provider.

If the user selects SAVE and there is not an empty space for the game content, one of the old games/game levels has to be replaced with the new one. An Information Note “NO SPACE” is displayed, and then a selection list of games/game levels is displayed. The user can scroll through the list using the scroll keys. Softkey labels are “SELECT” and “BACK”. The header is “REPLACE GAME”/“REPLACE GAME LEVEL”.

The phone displays a Confirmation Query with display text “REPLACE GAME?”/“REPLACE GAME LEVEL?”. If storing is not successful the Information note “SAVE FAILED” is displayed.

Discard.

If the user selects the DISCARD one row choice item, a confirmation query with the text “DISCARD GAME LEVEL”/“DISCARD GAME” is displayed. If the user accepts the query, the game content is discarded, and a Confirmation Note with text “GAME LEVEL DISCARDED”/“GAME DISCARDED”, and the phone returns to a WAP page specified by the content provider. If the user rejects the query, the phone returns to the downloaded game content options list (see above).

Downloading Images

The Smart Content Download mechanism according to the preferred embodiment of the invention can handle two types of images:

Picture Message images: downloaded using Nokia Smart Message format Picture Message, and

Screen Saver images: downloaded using Graphics Interchange Format (gif) images—both still and animated.

Purchase Picture Message

From the WAP page, the user can select a link to purchase a picture message. The text used is defined by the content provider. After selecting the link, content download is initiated. When download is complete, the user is informed by means of a note with text “PICTURE MESSAGE DOWNLOADED”. The layout used is Confirmation Query. The left softkey is “OPTION”, and the right softkey is “BACK”. By pressing the “OPTIONS” softkey, one row choice items will be displayed, including “Save”, “View”, and “Discard”. The header text is “PICTURE MESSAGE OPTIONS”.

If the user presses the “BACK” softkey from either the Confirmation Query or the Selection List, a confirmation query with the text “DISCARD PICTURE MESSAGE” is displayed. If the user accepts the query, the picture message is discarded, and a Confirmation Note with text “PICTURE MESSAGE DISCARDED” is displayed. If the user rejects the query, the phone returns to the options list.

Save.

If the user selects the “SAVE” one row choice item, the downloaded picture message is saved to the phones memory.

When the user selects the item, a Confirmation Note with text “PICTURE MESSAGE SAVED” is displayed. The display then returns to a WAP page specified by the content provider.

If the user selects “SAVE” and there is not an empty space for the picture message, one of the old pictures has to be replaced with the new one. An Information Note “NO SPACE” is displayed, and then a list of picture messages is displayed, with one image displayed at a time. The user can scroll through the images using the scroll keys. Left and right softkeys are “SELECT” and “BACK”, respectively. The header is “REPLACE PICTURE MESSAGE”.

The phone displays a Confirmation Query with display text “REPLACE PICTURE MESSAGE?” If storing is not successful the Information note “SAVE FAILED” is displayed.

View.

If the user selects the “VIEW” one row choice item, the downloaded picture message is displayed. The header is “DOWNLOADED PICTURE MESSAGE”. The right softkey is “BACK”. The left softkey is inactive. By pressing “BACK”, the user is brought back to the downloaded picture message selection list (see above).

Discard.

If the user selects the “DISCARD” one row choice item, a confirmation query with the text “DISCARD PICTURE MESSAGE” is displayed. If the user accepts the query, the picture message is discarded, and a Confirmation Note with text “PICTURE MESSAGE DISCARDED”, and the phone returns to a WAP page specified by the content provider. If the user rejects the query, the phone returns to the downloaded picture message options list (see above).

Preview Picture Message

From the WAP page, the user can select a link to preview a picture message. The content provider defines the text used. If the user selects the preview link, the selected picture message is displayed. The header is “PICTURE MESSAGE”. The right softkey is “BACK”, while the left softkey is inactive. By pressing the “BACK” softkey the phone is brought back to the WAP page.

Purchase Screen Saver

From the WAP page, the user can select a link to purchase a screen saver. The content provider defines the text used. After selecting the link, content download is initiated.

When download is complete, the user is informed by means of a note with text “SCREEN SAVER DOWNLOADED”. The layout used is Confirmation Query. The left softkey is “OPTIONS”, and the right softkey is “BACK”. By pressing the “OPTIONS” softkey, a selection list of one row choice items will be displayed, including the items:

Save and activate,

Save,

View, and

Discard.

The header text is “SCREEN SAVER OPTIONS”. If the user presses the “BACK” softkey from either the Confirmation Query or the Selection List, a confirmation query with the text “DISCARD SCREEN SAVER?” is displayed. If the user accepts the query, the screen saver is discarded, and a Confirmation Note with text “SCREEN SAVER DISCARDED” is displayed. If the user rejects the query, the phone returns to the options list.

Save and Activate

If the user selects the “SAVE AND ACTIVATE” one row choice item, the downloaded screen saver is saved and activated as the screen saver for the currently selected profile.

When the user selects the item, a Confirmation Note with text “SCREEN SAVER SAVED AND ACTIVATED” is displayed. The display then returns to a WAP page specified by the content provider.

If the user selects “SAVE AND ACTIVATE” and there is not an empty space for the screen saver, one of the old screen savers has to be replaced with the new one. An Information Note “NO SPACE” is displayed, and then a list of screen savers is displayed, with one image displayed at a time. The user can scroll through the screen savers using the scroll keys. Softkeys are “SELECT” and “BACK”. The header is “REPLACE SCREEN SAVER”. The phone displays a Confirmation Query with display text “REPLACE SCREEN SAVER?”. If storing is not successful the Information note “SAVE FAILED” is displayed.

If the image is larger than the maximum allowed screen saver size, the user is prompted to crop the image in accordance to the maximum size required for the application. The cropping of images and animations may be performed as described by the applicant in GB0104994.9. GB0104994.9 and patent applications claiming priority therefrom is hereby incorporated by reference.

If the user selects the “SAVE” one row choice item, the downloaded screen saver is saved to the phones memory. When the user selects the item, a Confirmation Note with text “SCREEN SAVER SAVED” is displayed. The display then returns to a WAP page specified by the content provider.

If the user selects “SAVE” and there is not an empty space for the screen saver, one of the old screen savers has to be replaced with the new one.

An Information Note “NO SPACE” is displayed, and then a list of screen savers is displayed, with one image displayed at a time. The user can scroll through the screen savers using the scroll keys. Softkey labels for the left and the right softkey are “SELECT” and “BACK”, respectively. The header text is “REPLACE SCREEN SAVER”.

When the user selects “SELECT”, the phone displays a Confirmation Query with display text “REPLACE SCREEN SAVER?” This Confirmation Query has to be confirmed by the user by pressing “select” or “OK”. If storing is not successful the Information note SAVE FAILED is displayed.

If the image is larger than the maximum allowed screen saver size, the user is prompted to crop the image in accordance to the maximum size required for the application.

View

If the user selects the “VIEW” one row choice item, the downloaded screen saver is displayed. The header is “DOWNLOADED SCREEN SAVER”. The softkey label of the right softkey is “BACK”. The left softkey is inactive. Pressing the “BACK” softkey brings the user back to the downloaded screen saver selection list.

Discard

If the user selects the “DISCARD” one row choice item, a confirmation query with the text “DISCARD SCREEN SAVER” is displayed. If the user accepts the query, the screen saver is discarded, and a Confirmation Note with text “SCREEN SAVER DISCARDED”, and the phone returns to a WAP page specified by the content provider. If the user rejects the query, the phone returns to the downloaded screen saver options list (discussed above)

Preview Screen Saver

From the WAP page, the user can select a link to preview a screen saver. The content provider defines text used. If the user selects the preview link, the selected screen saver is displayed. The header is “SCREEN SAVER”. The right softkey is “BACK”. The left softkey is inactive. Pressing “BACK” brings the phone back to the WAP page.

Smart Content Download—WAP Browser

When the WAP browser is launched from one of the Smart Content Download menu items, general back-stepping rules are used. When the user launches the browser from one of the Smart Content Download menu items, they are brought to a page defined by the link in the menu item. If the user selects the softkey having the softkey text “BACK” (or the Browser option item BACK), and the History list is empty, a Confirmation Query with the text “QUIT BROWSING?” is displayed. If the user accepts the Query, they return to the Smart Content Download menu item from which they launched the WAP browser. If the user rejects the query, they return to the WAP browser, with the page from which they attempted to back-step from displayed.

What is claimed is:

1. A method of handling payment of downloadable content from a content provider to a wireless terminal via a communication network, said method comprises step of
opening a software application in said wireless terminal,
requesting downloadable content from the open software application,
automatically starting up a network session,
transmitting in said network session a request for downloading said downloadable content for the software application,
receiving said downloadable content for the software application for pre-study,
handling of payment for said downloadable content for the software application for enabling storing of said downloadable content for the software application, and
storing of said downloadable content for the software application from which the downloadable content for the software application was requested.

2. A method according to claim 1, wherein the requested downloadable content includes at least one of the following items:
a ring tune,
a tactile feed back from a vibrator,
a graphic icon,
an animation, and
a new maze or background for a game.

3. A method according to claim 1, wherein the networks session is a WAP session.

4. A method according to claim 3, wherein the WAP session is established with a pre-identified content provider.

5. A method according to claim 4, wherein the user of the wireless terminal has an account at the pre-identified content provider, and wherein the handling of payment for said downloadable content includes transfer of an amount from said account to the content provider upon approval by the user.

6. A method according to claim 5, wherein the storing of said downloadable content is enabled once the user has approved said payment.

7. A method according to claim 3, wherein the WAP session is established with a pre-identified Internet portal hosting at least one content provider.

8. A method according to claim 4, wherein the user of the wireless terminal has an account at the pre-identified Internet portal, and wherein the handling of payment for said downloadable content includes transfer of an amount from said account to the content provider upon approval by the user.

9. A method according to claim 5, wherein the storing of said downloadable content is enabled once the user has approved said payment.

10. A wireless terminal via a communication network, and comprising:
at least one software application,
said at least one software application comprises means for the user for requesting downloadable content,
means for automatically starting up a network session upon detection of a user entered request,
means for transmitting a request in said network session for downloading said downloadable content to a content source,
means for receiving said downloaded content for the software application for pre-study,
means for handling of payment for said downloaded content for the software application, and
means for storing of said downloaded content for use with the software application from which the downloadable content was requested once payment has been handled.

11. A wireless terminal according to claim 10, wherein the requested downloadable content includes at least one of the following items:
a ring tune,
a tactile feed back from a vibrator,
a graphic icon,
an animation, and
a new maze or background for a game.

12. A wireless terminal according to claim 10, wherein the networks session is a WAP session.

13. A wireless terminal according to claim 12, wherein the WAP session is established with a pre-identified content provider.
